(19) United States
(12) Patent Application Publication
(10) Pub. No.: US 2017/0330315 A1
(43) Pub. Date: Nov. 16, 2017

(54) INFORMATION PROCESSING APPARATUS, METHOD FOR PROCESSING INFORMATION, DISCRIMINATOR GENERATING APPARATUS, METHOD FOR GENERATING DISCRIMINATOR, AND PROGRAM

(71) Applicant: Canon Kabushiki Kaisha, Tokyo (JP)

(72) Inventor: Hiroshi OKUDA, Utsunomiya-shi (JP)

(21) Appl. No.: 15/532,041

(22) PCT Filed: Dec. 3, 2015
(86) PCT No.: PCT/JP2015/006010

§ 371 Date: May 31, 2017

(30) Foreign Application Priority Data
Dec. 12, 2014 (JP) 2014-251882
Sep. 11, 2015 (JP) 2015-179097

(51) Int. Cl. G06T 7/00; G01N 21/88

(52) U.S. Cl. CPC G06T 7/001; G01N 21/8851; G06T 2207/20081; G01N 2021/8887; G06T 2207/30164; G06T 2207/20016

(57) ABSTRACT

To conduct defective/non-defective determination on an inspection image with high accuracy, while preventing a feature amount from becoming higher in dimension, and increasing in arithmetic processing time, an inspection image which includes an object to be inspected is acquired; a plurality of hierarchy inspection images by conducting frequency conversion on the inspection image is generated; feature amounts corresponding to types of defects which may be included in the object to be inspected regarding at least one hierarchy inspection image among the plurality of hierarchy inspection images are extracted; and information on the defect of the inspection image based on the extracted feature amount is output.

### TECHNICAL FIELD

The present invention relates to a method for determining whether an object is defective or non-defective by capturing an image of the object and using the image for the determination.

### BACKGROUND ART

Products manufactured in, for example, factories are generally subject to visual inspection to determine whether they are non-defective or defective. A method for detecting defects by image processing to an image of an object to be inspected in cases where how defects included in defective products (e.g., intensity, magnitude, and positions) appear is known in advance has been in practical use. Actually, however, how defects appear is often unstable and they have various intensity, magnitude, positions, and the like. Therefore, inspections are often conducted by human eye and substantially not automated currently.

As a method for automating inspections of unstable defects, an inspection method in which a large number of feature amounts are used has been proposed. Specifically, images of samples of a plurality of non-defective products and defective products prepared for learning are captured, a large number of feature amounts, such as an average or distribution, and the maximum value of pixel values, and contrast, are extracted from those image, and a discriminator that classifies non-defective products and defective products with respect to the high-dimension feature amount space is generated. Then an actual object to be inspected is determined to be non-defective or defective using the discriminator.

If the amount of feature amounts becomes large relative to the sample number for learning, the following problem may occur: a discriminator overfits on non-defective products and defective products of the samples during learning, and a generalization error to the object to be inspected becomes large. If the number of feature amounts is large, redundant feature amounts may be generated, and processing time may be increased. Therefore, a technique to reduce generalization error and increase the speed of arithmetic operations by selecting appropriate feature amount among a large number of feature amounts has been proposed. In PTL 1, a plurality of feature amounts are extracted from a reference image, and a feature amount used for discrimination of an inspection image is selected to discriminate an image.

If the method of PTL 1 is used, defect signals can be extracted with the related art feature amounts, such as the average, the distribution, the maximum value, and the contrast, regarding defects with strong defect signals among various defects. However, defects with weak defect signals and defects depending on the number of the defects even if their defect signals are strong are difficult to extract as feature amounts. For the reason, accuracy in defective/non-defective determination to the inspection image has been significantly low.

### CITATION LIST

### Patent Literature

PTL 1: Japanese Patent Laid-Open No. 2005-309878

### SUMMARY OF INVENTION

A non-defective inspection apparatus of the present disclosure includes an acquisition unit configured to acquire an inspection image which includes an object to be inspected; a generation unit configured to generate a plurality of hierarchy inspection images by conducting frequency conversion on the inspection image; an extraction unit configured to extract feature amounts corresponding to types of defects which may be included in the object to be inspected regarding at least one hierarchy inspection image among the plurality of hierarchy inspection images; and an output unit configured to output information on the defect of the inspection image based on the extracted feature amount.

A discriminator generating apparatus of the present disclosure includes an acquisition unit configured to acquire a learning image including an object body for which whether it is non-defective or defective has been known; a generation unit configured to generate a plurality of hierarchy leaning images by conducting frequency conversion on the learning image; an extraction unit configured to extract feature amounts corresponding to types of defects to at least one hierarchy learning images among the plurality of hierarchy learning images; and a generation unit configured to generate a discriminator that outputs information on a defect of the object body based on the extracted feature amount.

According to the present disclosure, determination as to whether a defect is included in an inspection image can be conducted with high accuracy, while preventing the feature amount from becoming higher in dimension, and increasing in arithmetic processing time.

Further features of the present invention will become apparent from the following description of exemplary embodiments with reference to the attached drawings.

### BRIEF DESCRIPTION OF DRAWINGS

FIG. 1 illustrates a functional block configuration of a discriminator generating apparatus in the present embodiment.

FIG. 2 illustrates a functional block configuration of a defective/non-defective determination apparatus in the present embodiment.

FIG. 3 is a flowchart of a process in the present embodiment.

FIG. 4 illustrates a method for generating a pyramid hierarchy image in the present embodiment.

FIG. 5 illustrates pixel numbers for describing wavelet transformation.

FIG. 6 is a classification diagram of a defective shape captured on an image.

FIG. 7 is a schematic diagram of a method for calculating a feature amount that emphasizes a dot defect.

FIG. 8 is a schematic diagram of a method for calculating a feature amount that emphasizes a linear defect.

FIG. 9 is a schematic diagram of a method for calculating a feature amount that emphasizes a nonuniformity defect.

FIG. 10 illustrates exemplary feature extraction when a feature amount that emphasizes a linear defect is used to a pyramid hierarchy image.

FIG. 11 illustrates types and hierarchy levels of images used to three types of feature amounts: a dot defect, a linear defect, and a nonuniformity defect, and general statistics values.

FIG. 12 illustrates an exemplary hardware configuration of a discriminator generating apparatus and a defective/non-defective determination apparatus of the present embodiment.

### DESCRIPTION OF EMBODIMENTS

Hereinafter, forms (i.e., embodiments) for implementing the present invention are described with reference to the drawings.

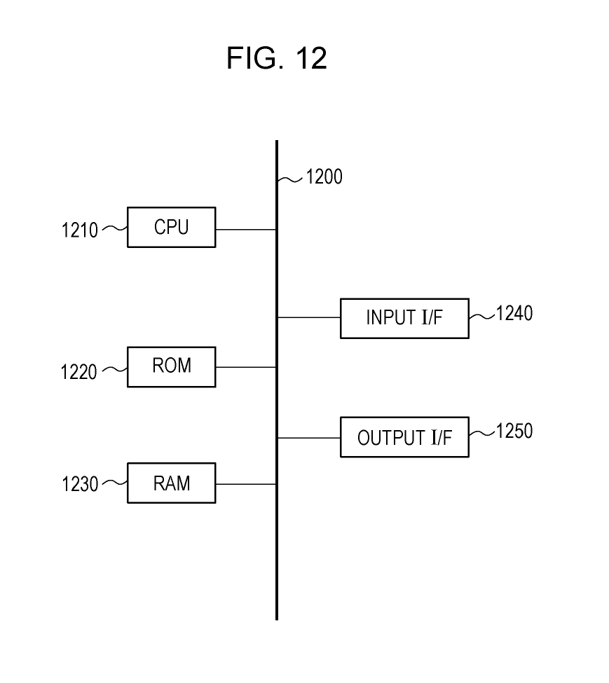

Before the description of each embodiment of the present invention, a hardware configuration on which a discriminator generating apparatus 1 or a defective/non-defective determination apparatus 2 described in the present embodiment is mounted is described with reference to FIG. 12.

FIG. 12 is a hardware configuration diagram of a discriminator generating apparatus 1 or a defective/non-defective determination apparatus 2 in the present embodiment. In FIG. 12, a CPU 1210 collectively controls devices connected via a bus 1200. The CPU 1210 reads and executes process steps and programs stored in read-only memory (ROM) 1220. An operating system (OS), each processing program related to the present embodiment, a device driver, and the like are stored in the ROM 1220, are temporarily stored in random-access memory (RAM) 1230, and are executed by the CPU 1210. An input I/F 1240 inputs a signal from an external apparatus (e.g., a display apparatus or a manipulation apparatus) as an input signal in a format processable in the discriminator generating apparatus 1 or the defective/non-defective determination apparatus 2. An output I/F 1250 outputs a signal to an external apparatus (e.g., a display apparatus) as an output signal in a format processable by the display apparatus.

### First Embodiment

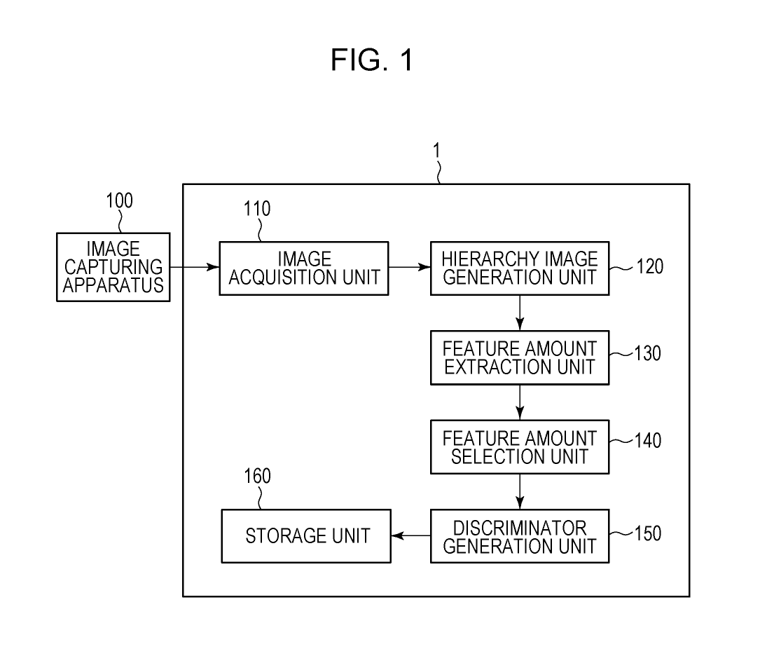

FIG. 1 illustrates a configuration of the discriminator generating apparatus 1 in the present embodiment. The discriminator generating apparatus 1 of the present embodiment includes an image acquisition unit 110, a hierarchy image generation unit 120, a feature amount extraction unit 130, a feature amount selection unit 140, a discriminator generation unit 150, and a storage unit 160. The discriminator generating apparatus 1 is connected to an image capturing apparatus 100.

The image acquisition unit 110 acquires an image from the image capturing apparatus 100. An image to be acquired is a learning image acquired by capturing an image of an object as an inspection target by the image capturing apparatus 100. The object captured by the image capturing apparatus 100 is previously labeled as non-defective or defective by a user. In the present embodiment, the discriminator generating apparatus 1 is connected to the image capturing apparatus 100 from which an image is acquired. Alternatively, however, images captured in advance may be stored in a storage unit, and may be read from the storage unit.

The hierarchy image generation unit 120 generates a hierarchy image (i.e., a hierarchy learning image) in accordance with the image acquired by the image acquisition unit 110. Generation of hierarchy image is described in detail later.

The feature amount extraction unit 130 extracts a feature amount that emphasizes each of dot, linear, and the nonuniformity defects from the image generated by the hierarchy image generation unit 120. Extraction of the feature amount is described in detail later.

The feature amount selection unit 140 selects a feature amount effective in separating an image of non-defective product from an image of defective product based on the extracted feature amount. Selection of the feature amount is described in detail later.

The discriminator generation unit 150 generates a discriminator that discriminates an image of non-defective product from an image of defective product by performing a learning processing using the selected feature amount. Generation of the discriminator is described in detail later.

The storage unit 160 stores the discriminator generated by the discriminator generation unit 150 and types of feature amounts selected by the feature amount selection unit 140.

The image capturing apparatus 100 is a camera that captures an image of an object as an inspection target. The image capturing apparatus 100 may be a monochrome camera or a color camera.

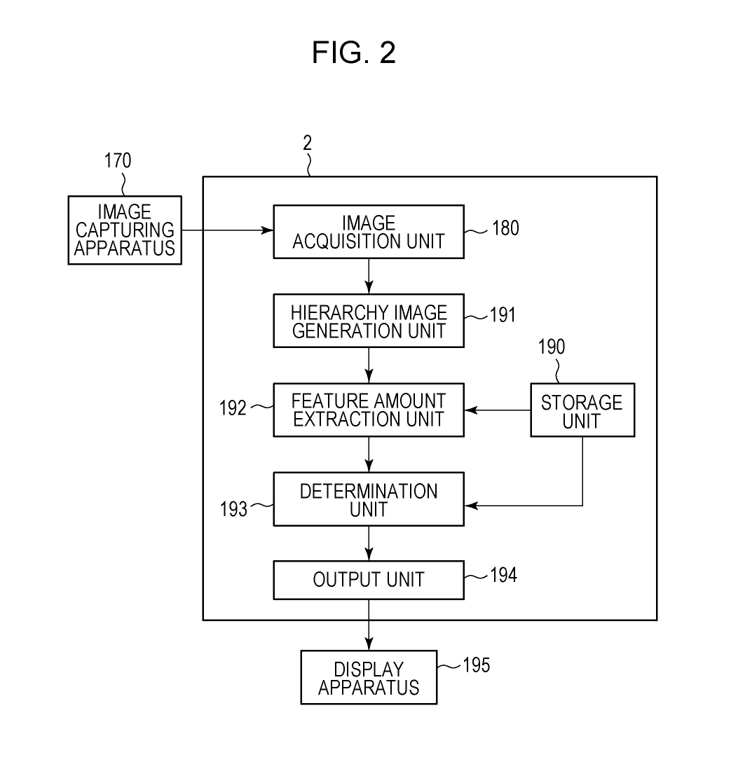

FIG. 2 illustrates a configuration of the defective/non-defective determination apparatus 2 in the present embodiment. Regarding an image of which non-defectively or defectively has not been known, the defective/non-defective determination apparatus 2 determines whether the image is an image of non-defective product or an image of defective product using the discriminator generated by the discriminator generating apparatus 1. The defective/non-defective determination apparatus 2 of the present embodiment includes an image acquisition unit 180, a storage unit 190, a hierarchy image generation unit 191, a feature amount extraction unit 192, a determination unit 193, and an output unit 194. The discriminator generating apparatus 1 is connected to an image capturing apparatus 170 and a display apparatus 195.

The image acquisition unit 180 acquires inspection image from the image capturing apparatus 170. The inspection image to be acquired is an image obtained by capturing an object as an inspection target, i.e., an image acquired by capturing, by the image capturing apparatus 170, an object of which non-defectively or defectively has not been known.

The storage unit 190 stores the discriminator generated by the discriminator generation unit 150, and types of feature amounts selected by the feature amount selection unit 140 of the discriminator generating apparatus 1.

The hierarchy image generation unit 191 generates a hierarchy image (i.e., a hierarchy inspection image) based on the image acquired by the image acquisition unit 110. A process of the hierarchy image generation unit 191 is the same process as that of the hierarchy image generation unit 120, which is described in detail later.

The feature amount extraction unit 192 extracts a feature amount of a type stored in the storage unit 190 among the feature amounts that emphasize each of dot, linear and nonuniformity defects from the image generated by the hierarchy image generation unit 191. Extraction of the feature amount is described in detail later.

The determination unit 193 separates an image of non-defective product from an image of defective product based on the feature amount extracted by the feature amount extraction unit 192 and the discriminator stored in the storage unit 190. Determination in the determination unit 193 is described in detail later.

The output unit 194 transmits a determination result to the display unit in a format displayable by the external display apparatus 195 via an unillustrated interface. In addition to the determination result, the output unit 194 may transmit the inspection image, the hierarchy image, and the like used in the determination.

The image capturing apparatus 170 is a camera that captures an image of an object as an inspection target. The image capturing apparatus 170 may be a monochrome camera or a color camera.

The display apparatus 195 displays the determination result output by the output unit 194. The output result may indicate non-defective/defective by text, color display, or sound. The display apparatus 195 may be a liquid crystal display and a CRT display. The display of the display apparatus 195 is controlled by the CPU 1210 (display control).

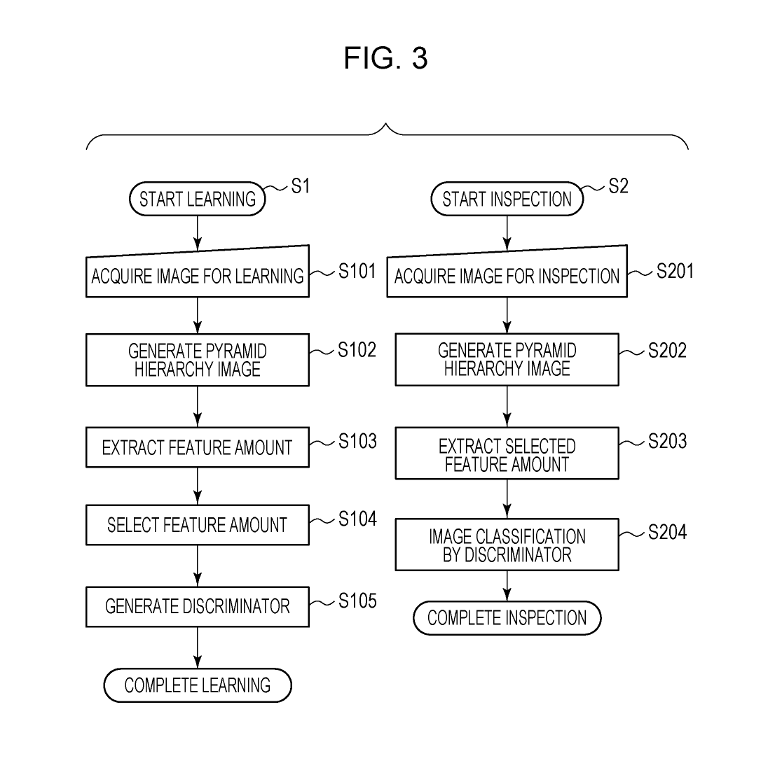

FIG. 3 is a flowchart of the present embodiment. Description is given hereinafter with reference to the flowchart of FIG. 3. An overview of the flowchart, and four features are described first, then detailed description of the flowchart is given.

### Overview of Flowchart of Embodiment and Features of the Present Invention

As illustrated in FIG. 3, the present embodiment has two different steps: a learning step S1 and an inspection step S2. In the learning step S1, images for learning are acquired (step S101), and a pyramid hierarchy image having a plurality of hierarchy levels and types to the images for learning is generated (step S102). Next, all the feature amounts are extracted with respect to the generated pyramid hierarchy image (step S103). Then, a feature amount used for the inspection is selected (step S104), and a discriminator used to discriminate an image of non-defective product and an image of defective product is generated (step S105).

In the inspection step S2, images for inspection are acquired (step S201), and a pyramid hierarchy image is generated as in step S102 with respect to the images for inspection (step S202). Next, the feature amounts selected in step S104 are extracted regarding the generated pyramid hierarchy image (step S203), and it is determined that the images for inspection are non-defective or defective using the discriminator generated in step S105 in which the discriminator is generated (step S204). The overview of the flowchart of the present embodiment has been described.

Next, features of the present invention are described. The present invention has four features, of which three features exist in step S102 in which the pyramid hierarchy image is generated and in step S103 in which the feature amounts are extracted.

The first feature is that a feature amount capable of extracting defects with weak defect signals or defects depending on the number of defects is used. Specifically, defects are classified into three types: dot defects, linear defects, and nonuniformity defects, and the feature amounts calculated with respect to a certain area in the image are used to emphasize each of them. Details of the defect and the feature amount are described later.

The second feature is that a pyramid hierarchy image having a plurality of hierarchy levels is prepared and a feature amount calculated with respect to regions of substantially the same size to each pyramid hierarchy image is used. To merely emphasize a defect, it is necessary to prepare a feature amount calculated with respect to regions of various sizes in accordance with the size of the defect. In the present invention, by using the feature amount calculated with respect to regions substantially same size to each pyramid hierarchy image, the calculation becomes equivalent to calculation with respect to regions of various sizes in simulation.

The third feature is that the hierarchy and the type of the pyramid hierarchy image are limited to those effective for each feature amount. In this manner, an accuracy reduction in the discriminator caused by the feature amount unrelated to the defect signal and an increase in calculation time caused by calculation of redundant feature amount extraction are avoidable.

The fourth feature of the present invention exists in S104 in which the feature amount is selected. By selecting the feature amount effective to separate an image of non-defective product from an image of defective product among a large number of feature amounts, the risk of overfitting can be reduced in step S105 in which the discriminator is generated. Further, calculation time can be reduced in step S203 in which the selected feature amount is extracted in the inspection step 2. The overview of the flowchart of the embodiment and the features of the present invention are described above.

### Detailed Description of Each Step

Hereinafter, each step is described in detail with reference to FIG. 3.

Step S1, which is the learning step, is described.

### Step S1

### Step S101

In step S101, the image acquisition unit 110 acquires an image for learning. Specifically, an exterior of a product of which non-defectively or defectively has already known is captured using, for example, an industrial camera and images thereof are acquired. A plurality of images of non-defective product and a plurality of images of defective product are acquired. For example, 150 images of non-defective product and 50 images of defective product are acquired. In the present embodiment, whether the image is non-defective or defective is defined in advance by a user.

### Step S102

In S102, the hierarchy image generation unit 120 divides the images for learning (i.e., a learning image) acquired in step S101 into a plurality of hierarchies with different frequencies, and generates a pyramid hierarchy image which is a plurality of image types. Step S102 is described in detail below.

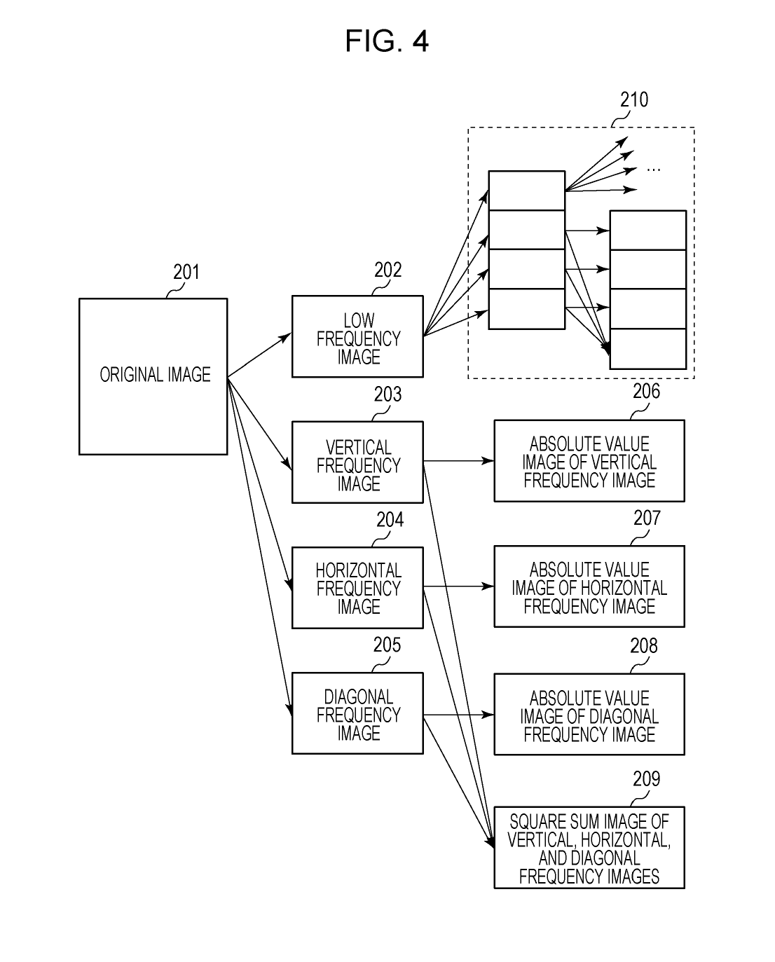

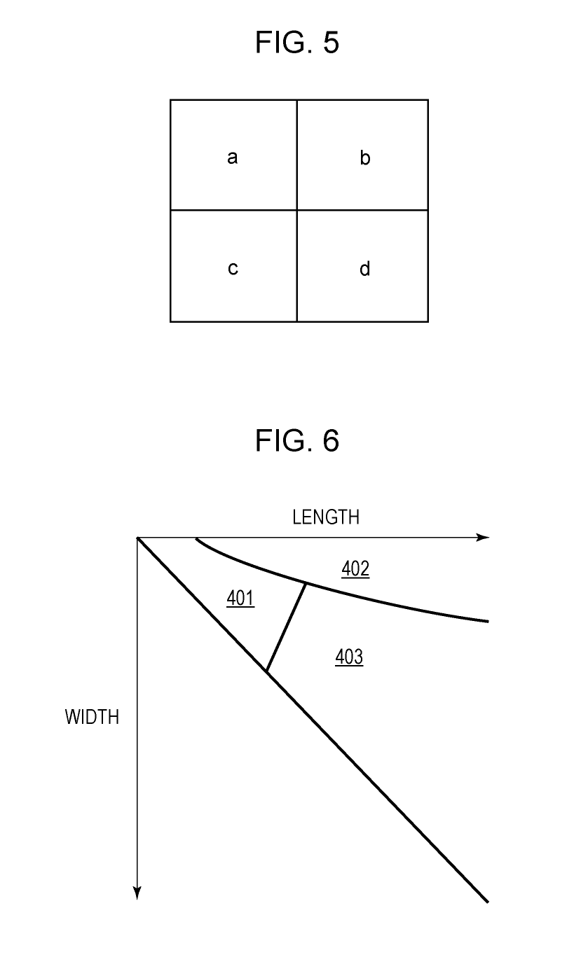

In the present embodiment, a pyramid hierarchy image (i.e., a hierarchy learning image) is generated using wavelet transformation (i.e., frequency conversion). A method for generating a pyramid hierarchy image is illustrated in FIG. 4. First, let an image acquired in step S101 be an original image 201 of FIG. 4, from which four types of images, a low frequency image 202, a vertical frequency image 203, a horizontal frequency image 204, and a diagonal frequency image 205, are generated. All of four types of images are reduced to one-fourth of the original image 201. FIG. 5 illustrates pixel numbers for describing wavelet transformation. As illustrated in FIG. 5, when the upper left pixel is a, the upper right pixel is b, the lower left pixel is c, and the lower right pixel is d, the low frequency image 202, the vertical frequency image 203, the horizontal frequency image 204, and the diagonal frequency image 205 are generated by converting each of the pixel values with respect to the original image 201 as follows:

(a+b+c+d)/4 (1)

(a+b−c−d)/4 (2)

(a−b+c−d)/4 (3)

(a−b−c+d)/4 (4).

Further, from the generated three types of images of the vertical frequency image 203, the horizontal frequency image 204, and the diagonal frequency image 205, four types of images of an absolute value image of the vertical frequency image 206, an absolute value image of the horizontal frequency image 207, an absolute value image of the diagonal frequency image 208, and a square sum image of vertical, horizontal, and diagonal frequency images 209 are generated. The absolute value image of the vertical frequency image 206, the absolute value image of the horizontal frequency image 207, and the absolute value image of the diagonal frequency image 208 are generated by obtaining each of absolute values of each of the vertical frequency image 203, the horizontal frequency image 204, and the diagonal frequency image 205. The square sum image of vertical, horizontal, and diagonal frequency images 209 is generated by calculating the square sum regarding all of the vertical frequency image 203, the horizontal frequency image 204, and the diagonal frequency image 205. Eight types of images 202 to 209 are referred to as an image group of a first hierarchy level relative to the original image 201.

Next, the same image conversion as was performed to generate the image group of the first hierarchy level is performed to the low frequency image 202 to generate eight types of images for a second hierarchy level. The same image conversion is repeated to the low frequency images of the second hierarchy level. As described above, this conversion is repeated to the low frequency image of each hierarchy level until the size of the image becomes a certain value or below. The repeating process is illustrated by the dotted line portion 210 in FIG. 4. By repeating the process, eight types of images are generated to each hierarchy level. For example, if the process is repeated to 10 hierarchy levels, 81 types (i.e., an original image+10 hierarchy levels×eight types) of images are generated to one image. This process is performed to all the images acquired in step S101.

Although the pyramid hierarchy image is generated using wavelet transformation in the present embodiment, other methods, such as Fourier transformation, may be used alternatively. Step S102 has been described above.

### Step S103

In step S103, the feature amount extraction unit 130 extracts feature amounts from each hierarchy generated in step S102 and from each type of the image. As described above, step S103 includes three especially characteristic features of the present invention. Hereinafter, the three features are described in order.

Feature Amount that Emphasizes Each of Dot Defect, Linear Defect, and Nonuniformity Defect

The first feature, which is the feature amount that emphasizes a dot defect, a linear defect, and a nonuniformity defect is described. FIG. 6 is a classification diagram of a defective shape captured on an image. In FIG. 6, the horizontal axis represents the length of a certain direction relative to a defect, and the vertical axis represents the direction perpendicular to the length (i.e., the width). With reference to FIG. 6, defective shapes in visual inspection can be classified into three types. The first defect is a dot defect denoted by 401 that is small both in length and width. The dot defect may have a strong signal. In some cases, a single defect may not be captured as a defect by a human eye, whereas a plurality of defects existing in a certain area may be captured as defects. An image of an object may sometimes be captured with dust or the like adhering to the exterior of the object at the image capturing location. A dot defect caused by the dust is not a defect, but it appears as a dot defect in the image capturing result. Therefore, the dot defect may or may not become a defect depending on the number thereof. The second defect is an elongated linear defect denoted by 402 extending in one direction. This image is generated mainly by a crack. The third defect is a nonuniformity defect denoted by 403 which is large in both length and width. The nonuniformity defect is generated by uneven coating or during a resin mold process. The linear defect 402 and the nonuniformity defect 403 often have weaker defect signals.

In the present invention, a feature amount that emphasizes a signal regarding the defect of each of these three types of shapes is extracted. Hereinafter, these are described in detail.

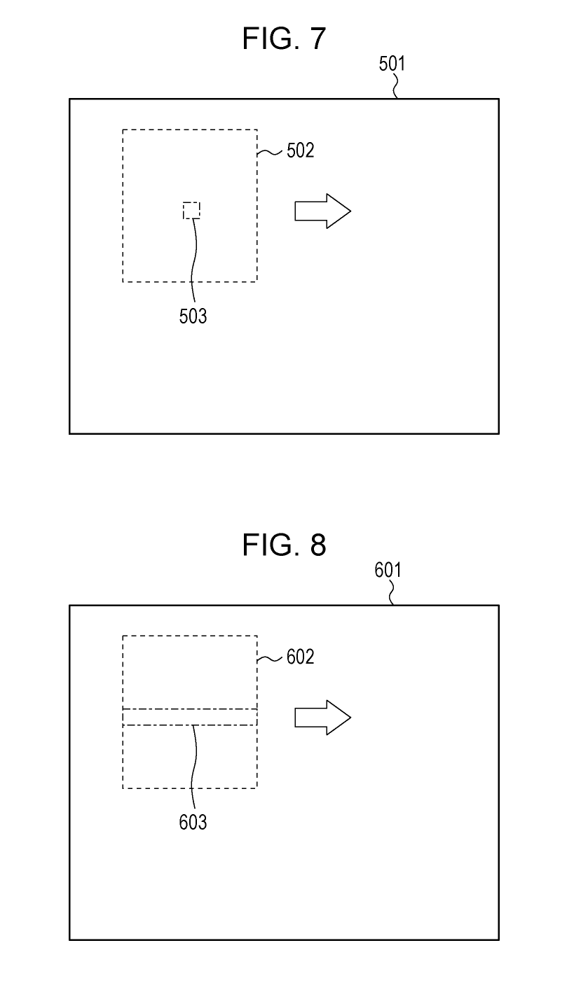

First, the feature amount that emphasizes the dot defect is described. FIG. 7 is a schematic diagram of a method for calculating a feature amount that emphasizes a dot defect. A rectangular region (i.e. a reference region) 501 (within a rectangular frame illustrated by a solid line in FIG. 7) is one of the pyramid hierarchy images generated in step S102. Regarding the image 501 (inside the hierarchy inspection image), a feature amount that emphasizes a dot defect is extracted from each pixel value in a predetermined rectangular region 502 (within a rectangular frame illustrated by a dotted line in FIG. 7) and a pixel value of the central pixel 503 of the rectangular region 502 (within the a rectangular frame illustrated by a dash-dot line in FIG. 7). In the present embodiment, an average value of pixels in the rectangular region 502 except the central pixel 503 and the pixel value of the central pixel 503 are compared with each other, and pixels with a certain comparison result or greater are calculated and set to be feature amounts. In this manner, the amount of pixels of which values are significantly higher than those of neighboring pixels can be calculated and, therefore, the number of dot defects can be considered as the feature amount.

Description is given using Expressions hereinafter. In the Expression, an average value except the pixel of the central pixel 503 is a_Ave, the standard deviation is a_Dev, and the pixel value of the central pixel 503 is b in the rectangular region 502. Here, m=4, 6 and 8, and |a_Ave−b|−mxa_Dev (5) is calculated. If Expression (5) is greater than 0, the comparison result is 1, whereas if Expression (5) is 0 or smaller, the result to the rectangular region 502 is 0. m is determined by setting how many times of the standard deviation to be a threshold and it is 4 times, 6 times, and 8 times in the present embodiment. Other values may be used alternatively. The calculation above is performed to the image 501 while scanning (corresponding to the arrow in FIG. 7), the number of pixels in which Expression (5) is 1 is calculated, and the feature amount that emphasizes the dot defect is obtained.

The second feature amount that emphasizes the linear defect is described. FIG. 8 is a schematic diagram of a method for calculating a feature amount that emphasizes a linear defect. A rectangular frame 601 in FIG. 8 illustrated by a solid line is one of the pyramid hierarchy images generated in step S102. Regarding the image 601, a convolution operation is conducted to extract a feature amount that emphasizes the linear defect using a rectangular region 602 (i.e., a rectangular frame in FIG. 8 illustrated by a dot line) and an elongated rectangular region 603 continued in one direction (i.e., a rectangular frame in FIG. 8 illustrated by a dash-dot line). In the present embodiment, a ratio between an average value of each of the pixel groups in the rectangular region 602 except the linear rectangular region 603 and an average value of the linear rectangular region 603 is calculated by scanning the entire image 601 (corresponding to the arrow in FIG. 8), and the maximum value and the minimum value are defined as the feature amounts. Since the rectangular region 603 is linear in shape, the feature amount with which the linear defect is emphasized more greatly is extractable. Although the image 601 and the linear rectangular region 603 are parallel with each other in FIG. 8, since the linear defect may occur in various directions of 360 degrees, the rectangular region 603 is rotated at 24 directions by 15 degrees, for example, and the feature amount is calculated at each angles.

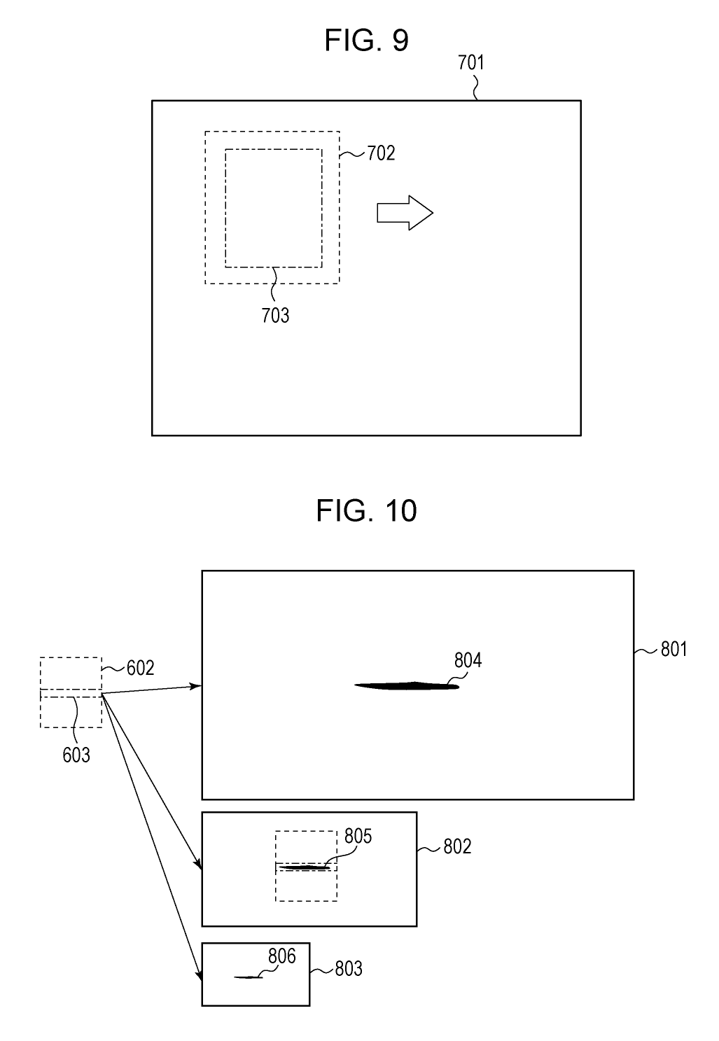

The third feature amount that emphasizes the nonuniformity defect is described. FIG. 9 is a schematic diagram of a method for calculating a feature amount that emphasizes a nonuniformity defect. A rectangular region 701 (within a rectangular frame illustrated by a solid line in FIG. 9) is one of the pyramid hierarchy images generated in step S102. As opposed to this image 701, a convolution operation is conducted to extract a feature amount that emphasizes the nonuniformity defect using a rectangular region 702 (within a rectangular frame in FIG. 9 illustrated by a dot line) and a rectangular region 703 (within a rectangular frame illustrated by a dash-dot line in FIG. 9) having a region which includes a nonuniformity defect inside the rectangular region 702. In the present embodiment, a ratio between an average value of the pixels in the rectangular region 702 except the rectangular region 703 and an average value of the rectangular region 703 is calculated by scanning the entire image 701 (corresponding to the arrow in FIG. 9), and the maximum value and the minimum value are defined as the feature amounts. Since the rectangular region 703 is a region which includes a nonuniformity defect, the feature amount that further emphasizes the nonuniformity defect is calculable.

The ratio between the average values is calculated in the feature amount that emphasizes the linear defect and the nonuniformity defect in the present embodiment. Alternatively, the ratio of distribution or the ratio of standard deviation may be used, and the difference instead of the ratio may be used. In the present embodiment, the maximum value and the minimum value are acquired after scanning, but other statistics values, averaging, distribution, may be used alternatively.

In the present embodiment, the three types of feature amounts that emphasize the defects are used to detect all the defects which may appear on an image. If the defect to appear is known in advance to be a dot defect and a linear defect, it is not necessary to use the feature amount of the nonuniformity defect.

The three types of feature amounts that emphasize the defects are used in the present embodiment. General statistics values, such as an average, distribution, kurtosis, skewness, the maximum value, and the minimum value, of pixel value of the pyramid hierarchy image used in the related art may be additionally used as the feature amounts.

### Feature Extraction Using Pyramid Hierarchy Image

Next, feature extraction using a pyramid hierarchy image which is the second feature is described. FIG. 10 illustrates exemplary feature extraction when a feature amount that emphasizes a linear defect is used to a pyramid hierarchy image. The rectangular region 602 and the linear rectangular region 603 are regions where the convolution operation for emphasizing the linear defect illustrated by FIG. 8 is conducted. The reference numerals 801, 802, and 803 denote, for example, an original image, a low frequency image of the first hierarchy level, and a low frequency image of the second hierarchy level. A linear defect 804 exists in the image 801, a linear defect 805 exists in the image 802, and a linear defect 806 exists in the image 803. Here, the feature amounts that emphasize the linear shape for one or several sizes of the regions are prepared and the feature amounts are used in the calculation to each hierarchy. When the feature amount for only one size of the region of the rectangular region 602 and the linear rectangular region 603 is prepared as illustrated in FIG. 10, a linear defect is not easily emphasized in the original image 801 and in the low frequency image 803 of the second hierarchy level, whereas the size of the linear defect and the size of the linear rectangular region 603 coincide with each other in the low frequency image 802 of the first hierarchy level, and the defect signal is further emphasized. Therefore, since the feature amount that emphasizes each defect is calculated relative to the pyramid hierarchy image, it is unnecessary to prepare the feature amount to calculate relative to regions of various sizes in accordance with the sizes of the defects.

Limitation of Hierarchy and Image Type in Accordance with Each Feature Amount

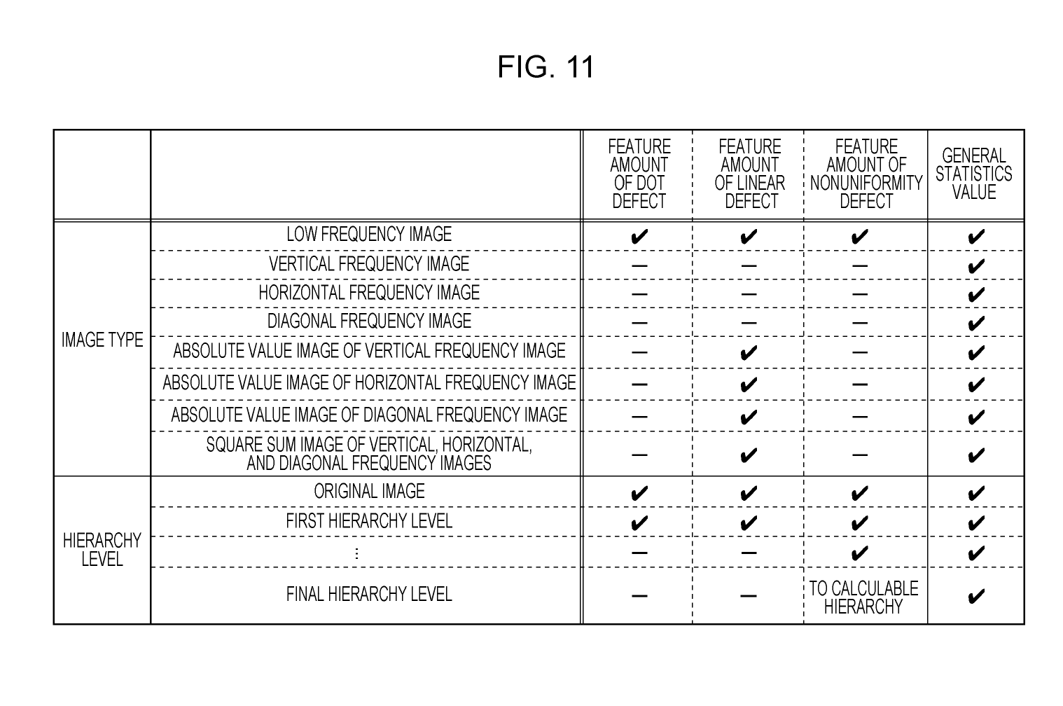

Next, the third feature of the present invention, i.e., limitation of hierarchy and image type in accordance with each feature amount is described. In the present invention, the hierarchy and the image type according to each feature amount are limited (i.e., selected) during extraction of the feature amount. FIG. 11 illustrates image types and hierarchy levels used to three types of feature amounts: a dot defect, a linear defect, and a nonuniformity defect, and general statistics values. The image types on the upper half of the vertical axis are types of the pyramid hierarchy images described in detail in step S102, and the hierarchy on the lower half of the vertical axis is used for the feature amount extraction. In general statistics value of the related art (i.e., averaging, distribution, and the maximum value), for example, all of the eight image types, and all the hierarchy levels including the original image, and from the first hierarchy level to the final hierarchy level are used as illustrated in FIG. 11. This is because the calculation cost is relatively low in the general statistics value.

In the feature amount that emphasizes the defect in the present invention, the calculation cost is high because the convolution operation and the like are conducted. If the feature amount is unrelated to a defect signal, accuracy reduction of discriminator may occur. Therefore, the image type and the hierarchy are limited in accordance with the feature amount. Hereinafter, the feature amounts of the three types of defects are described.

In the feature amount that emphasizes the dot defect, image type is limited to the low frequency image. This is because the dot defect may often have strong signal. The hierarchy levels to be used is limited to from the original image and the first hierarchy level to at most the second or the third hierarchy level. This is because the defect size of the dot defect is small, and the hierarchy level including the high frequency component is sufficient.

Next, a feature amount that emphasizes a linear defect, the image type is limited to the low frequency image, the absolute value image of the vertical frequency image, the absolute value image of the horizontal frequency image, the absolute value image of the diagonal frequency image, and the square sum image of vertical, horizontal, and diagonal frequency images. The linear defect is short in the direction perpendicular to the direction of the line (referred to as a perpendicular direction). This is because an average value in the linear rectangular region 603 may be large in the absolute value image which is edge-enhanced in the perpendicular direction, and may be extracted in a further emphasized manner as a feature amount. The hierarchy levels to be used is limited to from the original image and the first hierarchy level to at most the second or the third hierarchy level. This is because the defect size of the linear defect in the perpendicular direction is small, and the hierarchy level including the high frequency component is sufficient.

Next, in the feature amount that emphasizes nonuniformity defect, the image type is limited to the low frequency image. This is because, since a nonuniformity defect has a certain size in every direction, an effect that an average value of the rectangular region 703 having the region which includes the nonuniformity defect becomes large is reduced in the an absolute value image which is edge-enhanced. The used hierarchy level is the original image and from the first hierarchy level to a calculable hierarchy level. This is because the nonuniformity defect exists also in the low-frequency component, and calculation cannot be conducted to the final hierarchy level depending on the size of the rectangular region 703 which includes the nonuniformity defect.

Although the types and hierarchy levels of the pyramid hierarchy image are limited in the present embodiment, the types and the hierarchy levels of the image may further be limited depending on calculation speed and allowed time of the computer. Alternatively, allowed time may be input in the computer, and the types and the hierarchy levels of the image may be limited to be within the allowed time.

Step S103 in which the feature amount is extracted, including the three features has been described. When the size of the original image is about 1000×2000 pixels, the feature amount is about 1000 to 2000. The process in step S103 is thus completed.

### Step S104

In step S104, the feature amount selection unit 140 selects a feature amount effective in separating an image of non-defective product and an image of defective product among the feature amounts extracted in step S103. This is to reduce the risk of overfitting in step S105 in which the discriminator is generated. Further, this is because high-speed separation becomes possible by extracting only the feature amount selected during the inspection. For example, the feature amount can be selected by a filtering method or a wrapper method which are publicly known. A method for evaluating a combination of feature amounts may be used. Specifically, the feature amount is selected by ranking the types of the feature amount effective in separating non-defective products and defective products, and determining to which rank from the highest rank is used (i.e., the number of feature amounts to be used).

Ranking is created in the following manner. Here, the number of an object used for learning is j (j=1, 2, . . . , 200: in which 1 to 150 are non-defective products and 151 to 200 are defective products), i-th feature amount (i=1, 2, . . . ) of the j-th object is (x_{i,j}). An average xₐᵥₑ_{_}ᵢ and a standard deviation σₐᵥₑ_{_}ᵢ for the 150 non-defective products are calculated regarding the type of each feature amount, and assuming a probability density function f(x_{i,j}) generated by the frequency quantity (x_{i,j}) as normalization distribution. Here, f(x_{i,j}) is as follows:

$$\begin{matrix}[ Math . 1 ] & \\ f ( {x}_{i , j} ) = \frac{1}{\sqrt{2 {πσ}_{ave\_i}^{2}}} exp ( - \frac{{( {x}_{i , j} - {x}_{ave\_i} )}^{2}}{2 {σ}_{ave\_i}^{2}} ) . & ( 6 )\end{matrix}$$

Next, a product of probability density functions of all the defective products used for learning is calculated, and used as an evaluation value for ranking creation. Here, an evaluation value g(i) is:

$$\begin{matrix}[ Math . 2 ] & \\ g ( i ) = {\prod }_{j = 151}^{200} f ( {x}_{i , j} ) . & ( 7 )\end{matrix}$$

The smaller the value of the evaluation value g(i), the evaluation value g(i) becomes a more effective feature amount in separating the non-defective products and the defective products. Therefore, g(i) is sorted and ranking of the types of the feature amounts is created in descending order from those with smaller value.

As a method for creating a ranking a combination of the feature amounts may be evaluated. When evaluating a combination of the feature amounts, probability density functions corresponding to the number of dimensions of the feature amounts to combine are created and evaluated. For example, regarding the combination of the i-th and the k-th two-dimensional feature amounts, Expressions (6) and (7) are two-dimensionalized:

$$\begin{matrix} [ Math . 3 ] & \\ f ( {x}_{i , j} , {x}_{k , j} ) = \frac{1}{\sqrt{2 {πσ}_{ave\_i}^{2}}} exp ( - \frac{{( {x}_{i , j} - {x}_{ave\_i} )}^{2}}{2 {σ}_{ave\_i}^{2}} ) \times \frac{1}{\sqrt{2 {πσ}_{ave\_k}^{2}}} exp ( - \frac{{( {x}_{k , j} - {x}_{ave\_k} )}^{2}}{2 {σ}_{ave\_k}^{2}} ) , & ( 8 ) \\ [ Math . 4 ] & \\ g ( i , k ) = {\prod }_{j = 151}^{200} f ( {x}_{i , j} , {x}_{k , j} ) . & ( 9 )\end{matrix}$$

Regarding an evaluation value g(i, k), sorting is conducted with a fixed feature amount k, and points are provided in descending order from those with smaller value. For example, regarding a certain k, points are provided to the top 10 in the ranking: if a value g(i, k) is the smallest, 10 is provided to the feature amount i, and if g(i′, k) is the next smallest, 9 is provided to the feature amount i′. By providing the points to all the k, a ranking in consideration of the combination of the feature amounts is created.

Next, it is determined to which rank of the type of the feature amount from the highest rank is used (i.e., the number of feature amounts to be used). First, scores are calculated regarding all the objects used for learning with the number of feature amounts to be used being a parameter. Specifically, the number of feature amounts to be used is p, the type of feature amount sorted in the ranking is m, and the score h(p, j) of the j-th object is

$$\begin{matrix}[ Math . 5 ] & \\ h ( p , j ) = \sqrt{{\sum }_{m = 1}^{p} {( \frac{{x}_{m , j} - {x}_{ave\_m}}{{σ}_{ave\_m}} )}^{2}} . & ( 10 )\end{matrix}$$

Based on the score, all the objects used for learning are arranged in the order of the score, and the number of feature amounts p in which a degree of data separation is used as an evaluation value is determined. For the degree of data separation, the area under the curve (AUC) of the receiver operating characteristic curve (ROC) or transmission of non-defective products when overlooking of defective products of an image for learning is set to zero may be used. By using these methods, about 50 feature amounts calculated by feature extraction are selected. Step S104 in which the feature amounts are selected has been described.

### Step S105

In step S105, the discriminator generation unit 150 generates a discriminator. Specifically, the discriminator generation unit 150 determines a threshold with which whether a product is non-defective or defective is determined at the time of inspection relative to the score calculated using Expression (10). The user determines a threshold, such as whether defective products are to be partially overlooked, relative to the score to classify the non-defective products and the defective products depending on a production line situation. The discriminator generation unit 150 stores the generated discriminator in the storage unit 160. Alternatively, the discriminator may be generated by a support vector machine (SVM).

By method described above, the discriminator generating apparatus 1 generates a discriminator used for defect inspection. Next, a process conducted by the defective/non-defective determination apparatus 2 that performs defect inspection using the discriminator generated by the discriminator generating apparatus 1 is described.

The inspection step S2 in which inspection is conducted using the discriminator generated by the above method is described with reference to FIG. 3.

### Step S201

In step S201, the image acquisition unit 180 acquires an image for s inspection in which an object to be inspected is captured (i.e., an inspection image).

### Step S202

Next, in step S202, a pyramid hierarchy image (i.e., a hierarchy inspection image) is generated as in step S102 with respect to the inspection image acquired in step S201. At this time, a pyramid hierarchy image that is not used in the next step S203 in which the selected feature amount is extracted may not be generated. In that case, inspection processing time is further reduced.

In step S203 in which the selected feature amount is extracted, Regarding each image for inspection, the feature amount selected in step S104 is extracted based on the various methods in step S103. In step S204, based on the discriminator generated in S105, the image of non-defective product and the image of defective product are determined and images are classified. Specifically, scores are calculated using Expression (10) and, if the score is equal to or smaller than the threshold determined in step S105, the product is determined to be non-defective and, if the score is greater than the threshold, the product is determined to be defective. The invention is not limited to binary determination as non-defective and defective. Alternatively, two thresholds may be prepared and, if the score is equal to or greater than a first threshold, the product is determined to be non-defective, if the score is smaller than the first threshold or equal to or greater than the second threshold, determination is held, and if the score is smaller than the second threshold, the product is determined to be defective. In this case, the product of which determination is held may be visually inspected by human eye to obtain a more accurate determination result. The determination may also be ambiguous. The inspection step S2 has been described.

The present invention described above can provide an image classification method capable of extracting also defects with weak signals or defects depending on the number or density thereof, while preventing the feature amount from becoming higher in dimension.

### OTHER EMBODIMENTS

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-251882, filed Dec. 12, 2014, and No. 2015-179097, filed Sep. 11, 2015, which are hereby incorporated by reference herein in their entirety.

1. An information processing apparatus comprising:
an acquisition unit configured to acquire an inspection image which includes an object to be inspected;
a generation unit configured to generate a plurality of hierarchy inspection images by conducting frequency conversion on the inspection image;
an extraction unit configured to extract a feature amount corresponding to a type of defect which may be included in the object to be inspected regarding at least one hierarchy inspection image among the plurality of hierarchy inspection images; and
an output unit configured to output information on the defect of the inspection image based on the extracted feature amount.

2. The information processing apparatus according to claim 1, wherein the extraction unit extracts a feature amount corresponding to the type of defect while varying, for each type of defect, a reference region which is referred to during extraction of the feature amount.

3. The information processing apparatus according to claim 1, wherein the extraction unit extracts the feature amount based on a pixel in a predetermined region included in the at least one hierarchy inspection image and a pixel group in the region except the predetermined region pixel.

4. The information processing apparatus according to claim 3, wherein the feature amount is a feature amount indicating a dot defect.

5. The information processing apparatus according to claim 1, wherein the extraction unit extracts the feature amount based on a pixel group in a rectangular region in a predetermined region included in the at least one hierarchy inspection image, and a pixel group in the predetermined region except the pixel group in the rectangular region.

6. The information processing apparatus according to claim 5, wherein the feature amount is a feature amount indicating a linear defect.

7. The information processing apparatus according to claim 5, wherein the feature amount is a feature amount indicating a nonuniformity defect.

8. The information processing apparatus according to claim 1, further comprising a selection unit configured to select the at least one hierarchy inspection image from among the plurality of hierarchy inspection images, wherein the selection unit is selected depending on the type of defect.

9. The information processing apparatus according to claim 8, further comprising an acquiring unit configured to acquire allowed time input by a user, wherein the selection unit further selects the at least one hierarchy inspection image in accordance with the allowed time.

10. The information processing apparatus according to claim 14, wherein existence of an defect in the inspection image is output as information on a defect of the inspection image.

11. A discriminator generating apparatus comprising:
an acquisition unit configured to acquire a learning image including an object body for which whether a defect is included has already been known;
a generation unit configured to generate a plurality of hierarchy leaning images by conducting frequency conversion on the learning image;
an extraction unit configured to extract a feature amount corresponding to a type of defect to at least one hierarchy learning images among the plurality of hierarchy learning images; and
a generation unit configured to generate a discriminator that outputs information on a defect of the object body based on the extracted feature amount.

12. The discriminator generating apparatus according to claim 11, wherein the extraction unit extracts a feature amount corresponding to the type of defect while varying, for each type of defect, a reference region which is referred to during extraction of the feature amount.

13. The discriminator generating apparatus according to claim 11, wherein the extraction unit extracts the feature amount based on a pixel in a predetermined region included in the at least one hierarchy learning image and a pixel group in the region except the predetermined region pixel.

14. The discriminator generating apparatus according to claim 13, wherein the feature amount is a feature amount indicating a dot defect.

15. The discriminator generating apparatus according to claim 11, wherein the extraction unit extracts the feature amount based on a pixel group in a rectangular region in a predetermined region included in the at least one hierarchy learning image, and a pixel group in the predetermined region except the pixel group in the rectangular region.

16. The discriminator generating apparatus according to claim 15, wherein the feature amount is a feature amount indicating a linear defect.

17. The discriminator generating apparatus according to claim 15, wherein the feature amount is a feature amount indicating a nonuniformity defect.

18. A method for processing information, the method comprising:
acquiring an inspection image which includes an object to be inspected;
generating a plurality of hierarchy inspection images by conducting frequency conversion on the inspection image;
extracting a feature amount corresponding to a type of defect which may be included in the object to be inspected regarding at least one hierarchy inspection image among the plurality of hierarchy inspection images; and
outputting information on the defect of the inspection image based on the extracted feature amount.

19. A method for generating a discriminator, the method comprising:
acquiring a learning image including an object body for which whether a defect is included has already been known;
generating a plurality of hierarchy leaning images by conducting frequency conversion on the learning image;
extracting a feature amount corresponding to a type of defect to at least one hierarchy learning images among the plurality of hierarchy learning images; and
generating a discriminator that outputs information on a defect of the object body based on the extracted feature amount.

20. A computer-readable storage medium storing a program causing an information processing apparatus to perform the method according to claim 1.
